(19) United States
(12) Patent Application Publication
(10) Pub. No.: US 2023/0088151 A1
(43) Pub. Date: Mar. 23, 2023

(54) SYSTEM AND METHOD FOR DETERMINING THE INTEGRITY OF CONTAINERS BY OPTICAL MEASUREMENT

(71) Applicant: GasPorOx AB, Lund (SE)

(72) Inventors: Patrik Lundin, Harlösa (SE); Roland Koch, Boswil (CH)

(21) Appl. No.: 17/904,945

(22) PCT Filed: Feb. 25, 2021
(86) PCT No.: PCT/EP2021/054750

§ 371 Date: Aug. 24, 2022

(30) Foreign Application Priority Data
Feb. 25, 2020 (SE) 2050205-0

(51) Int. Cl. G01M 3/22; G01N 21/39; G01N 21/90; G01M 3/32

(52) U.S. Cl. CPC G01M 3/226; G01N 21/39; G01N 21/90; G01M 3/3272; G01N 2021/399

(57) ABSTRACT

A method and system for determining an integrity of a container, including obtaining a pressure inside a container by producing, filling and/or sealing a container using heat or at cold conditions. Transmitting a light signal through a headspace of the container and determining, based on the transmitted light signal being detected, the integrity of the container.

### BACKGROUND OF THE INVENTION

### Field of the Invention

This disclosure pertains to determining the integrity of closed containers by performing optical measurements for detection of the pressure and/or gas composition inside the container. Especially, the disclosure relates to packages that are produced or sealed using heat; or produced or sealed at cold conditions; for example glass ampoules or blow fill seal containers.

### Description of the Prior Art

The integrity of containers is important for several reasons, e.g., to keep the contents of the package inside the container; to keep any pre-filled gas composition inside the container at desired levels; to keep outside atmospheric gases from entering the container; to keep bacteria, viruses or other biological agents from entering.

Another reason why the integrity of a container may be of great importance is to prevent degradation of the contents and to ensure a safe product.

The integrity of the package may be especially important in the case of sterile products, like a parenteral drug. A leak in the container may thus compromise the quality and safety of the products, and may mean loss of sterility.

The integrity of sealed containers may be compromised e.g. by deficiencies in the sealing process, or in the barrier materials, or due to damage during the production process or handling.

Verification of the integrity of sealed containers is important in many industrial settings. Examples include quality control of packaging of products such as pharmaceuticals and food.

Therefore, it is relevant to verify the primary packaging of a container used for pharmaceuticals, baby nutrition or other products for the maintenance of the sterility and or verification that it is free of leaks. The regulatory requirements do in some cases define that leak testing is mandatory. Especially in the manufacturing of sterile pharmaceuticals like parenteral drugs, existing regulations demand a 100% leak testing, or the verification of a specific condition of the container having, for example, a vacuum. Regulatory requirements are outlining to have a 100% leak test for thermally sealed containers. For containers sealed under vacuum, the maintenance of the vacuum shall be verified.

Several means to verify the integrity of containers are known in the art. Some types of containers can be inspected by automated vision systems to detect anomalies, but this may not detect small leaks, and the method is limited to certain kinds of containers. Small leaks can be detected by penetration tests using dyes or trace gases such as helium, but such tests are often destructive and slow. Another method is to subject the container to external variations in the outside atmosphere, e.g., by placing it in a (partial) vacuum chamber, or exerting overpressure on the container with atmospheric air or other gases, or combinations of these techniques. With this method, some additional means to detect a leak of a container is required, i.e., by controlling or measuring one or more parameters that may change as consequence of the variation in outside pressure or gas composition, if a leak is present. Several such techniques are known in the art. For example, transient pressure variation in the chamber may be recorded, and its behaviour may be indicative of a leak in the sample (differential pressure methods). As another example, if the container contains a gas species that is not present in normal air at significant concentrations, a gas detector may be placed in the test chamber (or at the outlet) to detect the presence of that gas species, indicating a leak.

Non-intrusive optical detection of gases inside packages for quality control is disclosed in patent EP 10720151.9 (Svanberg et al.). The principle of optical detection of the gas in the headspace of packages for the purpose of indicating leaks is known in the art. This method is based on that the gas inside the package may deviate from an assumed gas composition due to interaction with the surrounding atmosphere through the leak. However, in normal atmosphere, for small leaks, it may take a very long time before there is a detectable deviation of the gas composition inside a package, which makes the method impractical in many situations.

A faster determination of container integrity, based on optical measurements of the gas composition/pressure inside a sealed container, is covered by WO 2016/156622. Here the container is subjected to a surrounding with a forced change in gas concentration/pressure, thereby inducing a faster change inside the container if a leak is present, compared to the natural alternations observed in EP 10720151.9.

Another method is to use a gas detection cell to which leaked gas is extracted and detected. Drawbacks with this method is, for example, time for detection, complexity of the system, costly, the gas is diluted, and large volume of leaked gas is required to be able to detect a leakage.

There are situations where none of the methods previously described in the art are suitable for detecting a leak. One such example is for inline measurements, hence new improved apparatus and methods for detecting leaks in such containers would be advantageous.

In the case of thermally sealed packages where a 100% leak testing is regulatorily required the testing must be non-intrusive. In these cases, the differential pressure method is sometimes applied, where one or several of the containers are placed in a tight test chamber. The method, however, has limitations both in sensitivity and speed, and in the case where multiple containers are tested simultaneously it cannot tell which container is leaking. Further, the equipment is large and complex.

Another example applied to thermally sealed containers, is the High Voltage Leak Detection (HVLD) method. This method is commonly used in the field of leak testing of glass ampoules. The testing is based on the fact that the packaging material serves an electrical insulator. In case of a break of this insulation, this can be detected using an electrical field detecting the broken insulation. The method requires a relevant difference in the electrical conductivity of a leaky or non-leaky container. Many times, it is required to have minimum conductivity of the product inside the container. This typically requires a liquid in the ampoule. The ampoule is rotated or in another manner handled to make sure the liquid is covering the whole inside of the container and especially the position where the leak is existing. The liquid behind the container wall will act as a conductive media to generate an electrical discharge or a detection of a different electrical behaviour when a leak is existing compared to an intact container wall. This method generates questions about the energy applied to the drug substance and the potential of effecting the drug.

### SUMMARY OF THE DISCLOSURE

Accordingly, embodiments of the present disclosure preferably seek to mitigate, alleviate or eliminate one or more deficiencies, disadvantages or issues in the art, such as the above-identified, singly or in any combination by providing a system or method according to the appended patent claims for non-destructively determining the integrity of sealed containers.

The discloser is taking advantage of the basics of the processes when producing, filling or closing containers at conditions with an elevated or decreased temperature.

According to one aspect of the disclosure, a method of determining an integrity of a container is described. The method may include obtaining a pressure inside the container by producing, filling and/or sealing the container using heat or at cold conditions. The method may also include transmitting a light signal through a headspace of the container using an optical sensor. The optical sensor may be sensitive to at least one gas. The method may further include detecting a transmitted light signal and determining, based on said transmitted light signal being detected, the integrity of the container.

Some examples of the disclosure may include having a temperature of the container reaching an equilibrium with a surrounding before transmitting the signal. When the temperature tries to reach an equilibrium with the surrounding temperature a pressure difference between the inside and outside of the container may be generated. A pressure difference between an inside and outside of the container may be generated from an initial temperature change through a partial equilibration to a full equilibration of the temperature in the container and the surrounding.

Some examples of the disclosure may include determining the pressure inside the container and/or a concentration of the at least one gas inside the container based on the transmitted signal being detected.

Some examples of the disclosure may include using the pressure inside the container and/or the concentration of the at least one gas inside the container for determining the integrity of the container.

In some examples of the disclosure may the optical sensor be a light source and a detector. The light may be transmitted between the light source and the detector and the detected light signal may be an absorption signal, such as a Tunable diode laser absorption spectroscopy signal (TDLAS).

In some examples of the disclosure may the pressure be an under pressure, such as a partial vacuum, generated inside said container due to natural or intentional cooling of said container after producing, filling and/or sealing the container using heat.

In some examples of the disclosure may the pressure be an overpressure generated inside the container due to natural or intentional warming of the container after producing, filling and/or sealing the container at cold conditions.

Some examples of the disclosure may include determining the pressure inside the container using an absorption signal of the at least one gas being present in the container.

Some examples of the disclosure may include detecting a leak in the container, compared to an intact container, by observing an increased or a decreased pressure inside the container.

Some examples of the disclosure may include detecting a leak by detecting at least one gas not expected to be present in the container, or a higher concentration than expected of the at least one gas.

Some examples of the disclosure may include detecting a leak by not detecting the at least one gas expected to be present in the container, or a lower concentration than expected of the at least one gas.

In some examples of the disclosure may the at least one gas be present in the surrounding, such as in normal atmosphere, for example air.

In some examples of the disclosure may the package be an ampoule or a Blow Fill Seal package.

In a further aspect of the disclosure may a system for determining an integrity of a container be disclosed. The system is configured to carry out a method according to any of the aspects or examples described hereon. For example, the system may include a position for filling and/or sealing said container using heat or at cold conditions thereby obtaining a pressure inside the container.

The system may further include an optical sensor for transmitting a light signal through a gas filled portion of the container, such as a headspace, and detecting a transmitted light signal. The optical sensor may be sensitive to at least one gas.

The system may also include a control unit configured for determining, based on the transmitted light signal being detected, the integrity of said container.

### BRIEF DESCRIPTION OF THE DRAWINGS

These and other aspects, features and advantages of which examples of the disclosure are capable of will be apparent and elucidated from the following description of examples of the present disclosure, reference being made to the accompanying drawings, in which:

FIGS. 1A and 1B are illustrating a schematic example of a container, FIG. 1A without a leak and FIG. 1B with a leak;

FIG. 2 is illustrating a schematic example of a container in a surrounding;

FIG. 3 is illustrating a schematic example of an arrangement for measuring through a container using a gas sensing instrument;

FIG. 4 is illustrating a schematic example of an arrangement for applying a mechanical force on a container;

FIG. 5 is illustrating a schematic example a flow-chart for a method for measuring the integrity of a container;

FIG. 6 is illustrating a pressure measurement between ampoules being intact and having a leak; and

FIG. 7 is illustrating a difference in linewidth due to different pressure between an intact container having an under pressure and a leaking container.

### DESCRIPTION OF EXAMPLES

Specific examples of the disclosure will now be described with reference to the accompanying drawings. This disclosure may, however, be embodied in many different forms and should not be construed as limited to the examples set forth herein; rather, these examples are provided so that this disclosure will be thorough and complete, and will fully convey the scope of the disclosure to those skilled in the art.

The following disclosure focuses on examples of the present disclosure applicable to determining the integrity of containers produced, filled and/or sealed during heat or at cold conditions. When a temperature of the container tries to reach an equilibrium with the surrounding temperature, an underpressure, such as a partial vacuum, or overpressure may be created in the container. The integrity of the container can then be determined by performing optical measurements on the container for determining a pressure and/or a gas inside the container.

As described herein, this is advantageous for detecting leaks in a package or container, in particular non-flexible containers. However, it will be appreciated for the person skilled in the art that the description is not limited to this application but may be applied to many other systems where the integrity of containers needs to be determined.

It should be noted that in the examples described herein, it is not necessary to measure the gas concentration in absolute values. In some examples it is sufficient to measure a signal that is related to the gas concentration. In some examples, the spectroscopic signal is related to the gas pressure.

In some examples, at least one reference container is used, the reference container having no leaks, or having leaks with known characteristics. The measurement on the reference container provides a baseline signal which is used for comparison with the measured signals on subsequent containers.

Alternatively, a reference measurement may be performed without a container. A reference measurement without a container may be performed by measuring through air. This measurement may provide a linewidth of a gas in air. The linewidth can be associated to a gas pressure. A linewidth obtained from a measurement through the container, for the same gas, may then be compared to the linewidth obtained through air. The comparison may be used to detect a potential leakage. For example, a leaking container may have a gas pressure inside the container which is similar to the gas pressure outside the container when compared to a non-leaking container.

The air measurement may be performed over the same distance as the gas filled space in the container. For example, by measuring through air using the same sensor that may be used for measuring through a container, such as through a holder for a container. The measurement through air may be performed before and/or after the container has been measured.

Similar measurements may be conducted to measure a gas composition and/or concentration in a surrounding which may then be used as a reference to detect a leakage by measuring a gas composition and/or concentration inside a container.

The discloser is taking advantage of the basics of the processes when producing, filling or closing containers at conditions with an elevated or decreased temperature. Once the container is sealed, the temperature in the closed container will change when the temperature tries to reach an equilibrium with the surrounding temperature. This change of temperature may generate a pressure difference between the inside and outside of the container. The disclosure uses this pressure difference as a base for leak testing. A leak may therefore be possible to detect as soon as a pressure difference between the inside and outside of the container has been generated, i.e. from an initial temperature change through a partial equilibration to a full equilibration of the temperature in the container and the surrounding.

Containers are often produced or sealed using heat, which can be utilized for the leak testing. As the pressure inside a thermally sealed container without leak typically is automatically altered, a non-intrusive measurement of the gas pressure inside the container can serve as a leak testing. As the pressure difference may also induce a gas transport into a leaky container, a measurement of the headspace gas composition may also serve as a leak testing.

As an alternative, containers may, for example, be filled with a cold liquid, or in other ways produced or sealed at cold conditions. Again, as the temperature of the container tries to be equilibrated with the surrounding after sealing, the pressure inside may be altered. Measurements of the gas pressure inside the container can serve as a leak testing. The pressure difference may also induce a gas transport out from a leaky container, a measurement of the headspace gas composition may therefore serve as a leak testing.

The principle of the disclosure is described using the example of the production of glass ampoules. However, it could be applied to other containers using thermal influence for the production, like Blow Fill Seal (BFS) containers, or other containers which are produced or closed using thermal sealing; or containers which are produced, filled or sealed at cold conditions.

For example, the filling and sealing of glass ampoules are using a preformed, open container which is filled, e.g., with a liquid. For closing the ampoule, the glass is heated to melt the glass and the melted glass is closing the ampoule. During this process there is a thermal impact to the gas inside the container. The gas and other content will be heated up during the sealing process. After the seal is made, the temperature will try to reach an equilibrium with ambient conditions. As the gas is in a closed headspace and the container has at least some mechanical stability, this process may generate a pressure which is different from the ambient. After the ampoule production there may thus be a partial vacuum inside the container. This change of the headspace condition is, in this disclosure, used to verify the container integrity. The relevant parameter to measure can be the pressure inside the ampoule, or a shift of the gas composition.

This method has the benefit, that it can be done with a mechanically less extensive setup, not requiring to rotate or move the ampoule, not requiring the placing of electrodes to a specific point where a risk of a leak is expected, the increase of the sensitivity when letting the container rest at the ambient conditions to allow a gas exchange, the possibility to do an integral test of containers with a complex geometry, avoiding any risk of an influence of the drug by potentially exposing it to high energy, allowing to have a conductive container wall, not requiring to have a conductive substance in the container, not requiring to have a liquid inside the container. Further, the disclosed method may be very fast and can thus enable a 100% leak testing of individual containers.

The pressure and gas composition inside the container may both be measured using optical absorption spectroscopy. Especially the method tunable diode laser absorption spectroscopy (TDLAS) may be applied.

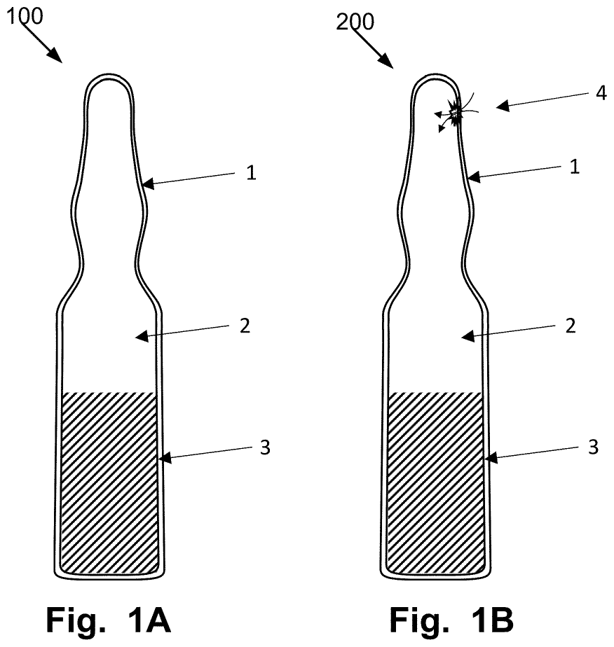

FIGS. 1A and 1B are illustrating a schematic example of a container 1, FIG. 1A without a leak and FIG. 1B with a leak 4, such as gas flowing into the container 1. Alternatively, depending on the pressure in the container compared to the surrounding, the gas may flow out of the container 1 through the leak. The containers 1 has a content 3 and a gas filled headspace 2.

The container is preferably a non-flexible container 1 made from glass or plastic. The container 1 should be transparent to at least one wavelength corresponding to a gas to be detected. For example, the container 1 may be a pharmaceutical or food package. In some other examples, the container 1 may be an ampoule or a Blow Fill Seal package.

Alternatively, the container 1 may be flexible, such as Blow Fill Seal packages made of a flexible material, such as a plastic material.

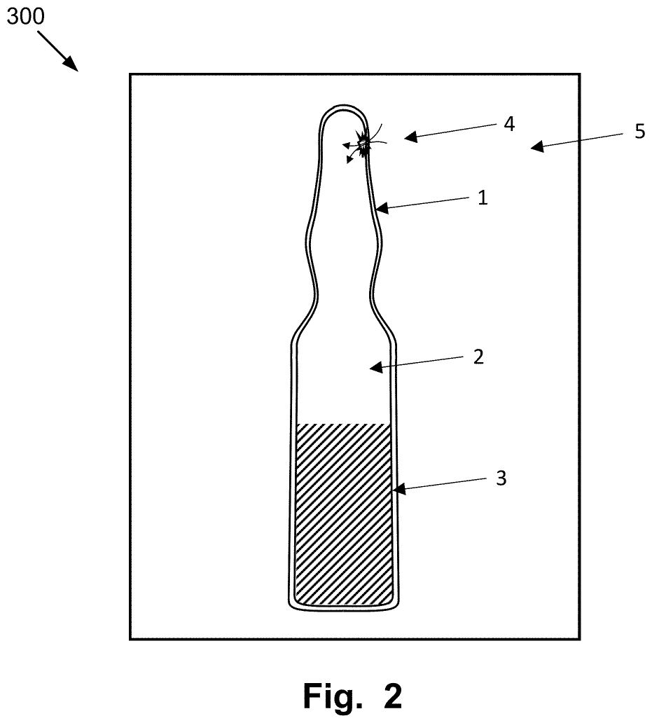

FIG. 2 is illustrating a schematic example 300 of a container 1 which has a content 3, a headspace 2 and is arranged in a surrounding 5. The surrounding may have an altered concentration and/or pressure of a gas. This may increase the detection rate of a leak 4. The surrounding 5 may be used for subjecting the container 1 to variations in outside pressure or gas composition, such as by placing it in a (partial) vacuum or underpressure, or exerting overpressure on the container 1 with atmospheric air or other gases, or combinations of these steps.

The purpose of changing a gas pressure, a gas composition, a gas concentration, or any combination of gas pressure, gas concentration and gas composition in a surrounding 5 of the container 1 is to further impose change to the concentration, or composition, or pressure, of the gas or gases inside the container 1 as result of any leaks in the container compared to only using the overpressure or under pressure obtained in the container 1 due to the producing, filling and/or sealing using heat, or, at cold conditions.

When performing a combination of changing the gas pressure, gas composition, or gas concentration, this may be done either simultaneously, for example by applying an overpressure or underpressure together with a change in gas concentration or composition. Alternatively, and/or additionally, in some examples, the combination of the changes to the gas pressure, gas composition or gas concentration may be done sequentially, for example by, in a first step, applying an underpressure using one gas concentration or gas composition followed by, a second step, applying an overpressure with the same gas composition or gas concentration, or the other way round first applying an overpressure followed by an underpressure. In some examples, different gas concentration or gas compositions are used in the first step and the second step. In another example, the pressure is the same in the first step and the second step only the gas concentration or gas composition is changed.

It is also possible to simultaneously apply different pressures for different molecules in the gas composition by applying a partial change in gas pressure for a particular molecule and a different partial pressure for another molecule, for example by changing the gas concentration or composition, one molecule may be exposed to a partial underpressure while a second molecule may be exposed to a partial overpressure.

An advantage with applying vacuum or underpressure is to increase the diffusion of gas from inside the container 1 to outside. This is especially an advantage when there is an overpressure in the container 1. A detected decrease of the gas inside the container 1 means that there may be a leakage 4.

An advantage with applying overpressure in a surrounding 5, especially if there is an underpressure in the container 1, is to increase the diffusion by forcing a gas into the container 1. The gas may be a gas not previously present in the container 1. If the new gas is detected inside the container 1 there may be a leakage 4. Alternatively, and/or additionally, a gas already present in the container 1 may be applied. If an increase of the gas concentration is detected inside the container 1 there may be a leakage 4.

Also, some containers 1 handle overpressure better than underpressure with minimal deformation to the container 1, and vice versa. Deformation to the containers 1 should preferably be avoided when performing measurements. It is therefore considered preferably if the containers 1 are made from a non-flexible material.

In an example of the disclosure includes applying a gas or mix of gases in the surrounding 5.

An advantage of applying a mix of at least two gases is, for example, that an improved sensitivity in detecting leakage may be achieved. Also, by measuring on at least two gases having different diffusion rates the size of the leakage 4 may be estimated.

A similar technique may be utilized by applying a single gas different from the gas inside the container 1 and measuring the concentration of both gases inside the container 1. By measuring on both gases, the sensitivity of detecting a leakage 4 may be increased. Also, if the gases diffuse in and out of the container 1 with different rates, the size of the leakage 4 may be estimated.

Another advantage of applying a gas outside the container 1 is that the container 1 may be exerted to a minimum of stress or strain due to an applied underpressure or overpressure that may deform the container. An example of the disclosure includes applying any combination of the steps of applying an overpressure, an underpressure, at least one gas, or mix of gas in sequence in the surrounding 5.

By using a combination of steps an increased difference in the measured signal may be obtained. For example, by first creating an underpressure in the surrounding 5 an underpressure may be obtained in the container 1 which may increase the diffusion of an applied gas or mix of gases. An even larger diffusion may be obtained by first applying an underpressure and then applying a gas or a mix of gases together with an overpressure.

By utilizing a combination of steps, the leakage may be easier characterized, for example through detection of the propagation of an overpressure or an underpressure, and the diffusion of a gas or mix of gases.

Alternatively, and/or additionally, a first gas or mix of gases may be applied to the surrounding 5 and the change in signal is detected, thereafter is a second gas or mix of gases applied to the surrounding 5 and the change in signal is again detected. Differences in properties, such as size or dipole moment, between different molecules may effect how the molecules diffuse through holes and passages. This may be utilized to detect a leakage 4 and to characterize the leakage 4.

In one example, a container 1 containing a gas, or mix of gases is placed in an enclosure. Then, the enclosure is at least partially evacuated of air. The enclosure is then filled with a different gas (or gases) that is not initially present inside the container, or which is present at a known concentration. Then, a measurement of the concentration of the different gas inside the container 1 is performed using an optical sensor consisting of a light source and a light detector. The presence of, or increased concentration of, the different gas inside the container 1 is indicative of a leak. In some examples, the different gas may consist of carbon dioxide.

In another example, the container 1 may be transported on a conveyance band through a surrounding 5 being a partial enclosure, such as a tunnel, or a walled space. Inside this partial enclosure 5 a pump may be used to apply a change to the gas pressure, gas composition, gas concentration or any combination thereof. The measurements may then be performed on the moving containers 1 by having them passing an optical sensor either after it has passed through the partial enclosure or simultaneously. In the partial enclosure the container may pass through different sections having different gas pressures, gas concentrations, or gas compositions.

Alternatively, the container 1 may pass through an open surrounding where a pump is used to apply a gas cloud for the container to pass through, for example by spraying a gas on the container. As previously described above, this may expose the container to a change in the gas concentration, gas composition, gas pressure or any combination thereof.

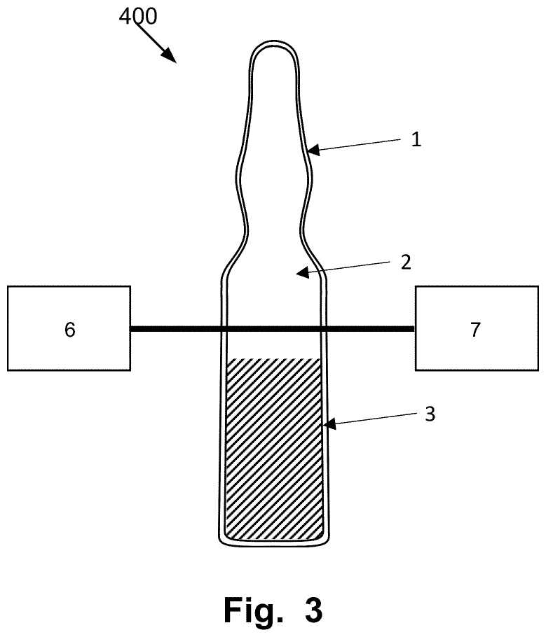

FIG. 3 is illustrating a schematic example 400 of an arrangement for measuring through a container 1 using a gas sensing instrument 6,7.

The illustrated arrangement could be adapted to perform the inspections inline. For example, by having the beam crossing a convey belt moving the containers.

The container 1 has a certain amount of gas is subjected to an integrity test in the system 400. In case there is a leak in the container, the gas inside the container may leak out into the surrounding and/or gas in the surrounding may leak into the container. Thus, an absolute concentration of the gas inside the container 1 may change, as may the pressure inside the container 1. An optical sensor 6, 7 is applied to the outside of the container 1, the sensor 6, 7 consisting of a light source 6 and a light detector 7. The sensor 6, 7 is configured for measuring on a headspace 2 of a container 1. Preferably, the sensor 6, 7 is designed or adjusted to detect the spectroscopic signal of at least one of the gases that are present inside the container 1.

In the described system, the light source 6 may be a white light source, for example transmitting a collimated light beam, or at least one laser source, such as a diode laser, a semiconductor laser. The wavelengths or wavelength range used for 5 the light source is selected to match the absorption spectra of at least one species of the gas inside the container. The detector 7 may be, for example, a photodiode, a photomultiplier, a CCD detector, a CMOS detector, a Si detector, an InGaAs detector, selected to be able to detect the wavelengths or wavelength range of the light source.

The detected light may be analysed in a control unit (not shown) for determining an alternated level of the at least one gas in the container 1. The control unit may be a computer, a microprocessor or an electronic circuit that could run code, or a software configured for analysing the light detected by the detector.

By detecting the at least one gas inside the container 1, it is possible to determine the pressure inside the container 1 and/or a concentration of the at least on gas inside the container 1 based on the detected transmitted signal. The measured pressure inside the container 1 and/or a concentration of the at least on gas inside the container 1 can be used to determine the integrity of the container 1.

In some examples, the optical sensor 6,7 consists of a sensor based on tunable diode-laser absorption spectroscopy (TDLAS).

In some examples, the optical sensor 6,7 consists of a sensor for gas in scattering media absorption spectroscopy (GASMAS). The GASMAS technique may be used for investigating sharp gas spectral signatures, typically 10000 times sharper than those of the host material, in which the gas is trapped in pores or cavities, such as headspaces 2 of a container 1. GASMAS combines narrow band diode laser spectroscopy, developed for atmospheric gas monitoring, with diffuse media optical propagation, well known from biomedical optics. Photons injected into a container 1 from a narrow band optical source may be detected in transmission or in backscattering arrangements. The technique has also been extended to remote sensing applications (LIDAR GASMAS or Multiple Scattering LIDAR. One example of a GASMAS sensor system and detection principle is described in EP 10720151.9 (Svanberg et al.) which is herein incorporated by reference.

The gas sensing instrument described in EP 10720151.9 consists of two diode lasers drivers for monitoring oxygen and water vapour inside a container. Monitoring of other gases or more than two gases are possible depending on the wavelengths used. The light from the diode lasers (DLs) is brought together and separated into two fibres—one used to monitor the background and one sent to the sample. The two diode lasers may operate at the wavelengths were the container 1 is translucent, making the GASMAS technique suitable. The laser light is guided to the headspace via optical fibres and a hand-held fibre head. The scattered light emerging out from the sample is acquired by a detector and the generated signal is sampled by a computer (not illustrated). In this example, wavelength modulation techniques are used to increase the sensitivity of the instrument by sinusoidally modulating the wavelength and studying the generated harmonics. In some examples, simultaneous detection of water vapour and oxygen is enabled by modulating at different frequencies.

The apparatus 400 may assess the containers 1 without contacting the containers 1 and instead detect the gas inside the packages from a remote distance. This is advantageous as the speed of detection may be increased and also for inline monitoring of containers.

The method described in EP 10720151.9 comprises emitting light from a narrow-band laser source towards the container from outside of the container. Measuring an absorption signal of the light scattered in the container, the absorption caused by at least one gas in the container when the light is scattered and travels in the container. The measuring is made outside of the container, and the assessment is non-intrusive with regard to the container.

Due to the scattering of the light in the sample a complication at the evaluation of the absorption signals obtained with the GASMAS method is the unknown gas interaction path length which the light has experienced.

The path length is important in traditional gas absorption spectroscopy for concentration quantification, as determined by the Beer-Lamberts law.

Other types of GASMAS systems and methods are described in the article “Optical Analysis of Trapped Gas—Gas in Scattering Media Absorption Spectroscopy”; Svanberg, S; Laser Physics, 2010, Vol. 20, No. 1, pp. 68-77; ISSN 1054-660X, these systems and methods described therein are incorporated by reference.

For example, oxygen and water vapour may be monitored simultaneously in transmission mode. Monitoring of other gases or more than two gases are possible depending on the wavelengths used. Alternatively, in some examples, the system 400 may be arranged for backscattering measurements. A common detector is used, and the two signals are separated by phase-sensitive detection of the two spectroscopic signals, tagged with different modulation frequencies. Partial common fibre optical pathways may be used. The GASMAS signal, which is recorded in, for example, arrangements such as those just described depends on the gas concentration in pores or headspaces, the gas, and on the effective path length through gas in the complex multiple scattering process. The strength of the recorded gas imprint is therefore generally expressed as an equivalent path length, Leq.

Alternatively, the mean path length through the scattering medium may be derived from time resolved measurements. Delayed coincidence single photon counting techniques may be used to obtain the histogram of photon arrival times.

In some examples, the optical sensor consists of an LED light source and a photodetector.

In some examples, the optical sensor consists of a sensor for photoacoustical detection.

In some examples, the optical sensor consists of a sensor for Raman spectroscopy of the gas inside the container.

In some examples, the optical sensor consists of a broad wavelength light source and a spectrometer.

In some examples, the optical sensor consists of a sensor for laser-induced breakdown spectroscopy of the gas inside the container.

In some examples, the optical sensor 6, 7 is working in transmission mode, i.e., the light transmitter 6 is located on one side of a headspace 2 of the container 1, and the light detector 7 is located on the opposite side of a headspace 2 of the container 1, and a light beam is transmitted from the light transmitter 6 through the container to the light detector 7.

In some examples, the optical sensor is working in reflection mode, i.e., the light transmitter is located on the same side of the container as the light detector, and the light detector 7 records back-scattered light from the container 1.

In some examples, the light transmitter 6 and the light detector 7 are positioned in arbitrary positions in relation to each other on the container 1, and the light detector 7 records scattered light from the container 1.

In some examples, the light is guided to and/or from the container by means of optical fibres. In some examples, the light is guided to and/or from the container via optical components including lenses, mirrors, windows, or other means of guiding and directing light.

In some examples, the optical sensor is working in reflection mode, i.e., the light transmitter is located on the same side of the container as the light detector, and the light detector records back-scattered light from the container.

In some examples, the light transmitter 6 and the light detector 7 are positioned in arbitrary positions in relation to each other on the container 1, and the light detector records scattered light from the container 1.

In some examples, the light is guided to and/or from the container by means of optical fibres. In some examples, the light is guided to and/or from the container 1 via optical components including lenses, mirrors, windows, or other means of guiding and directing light.

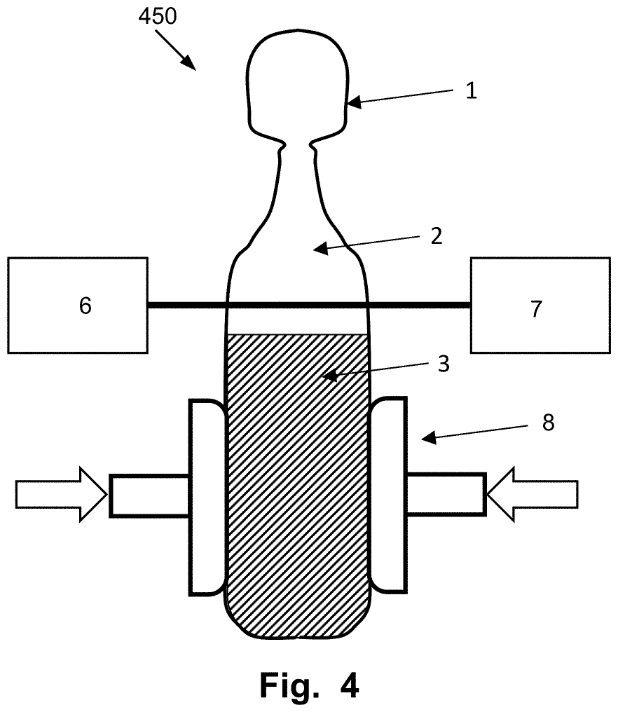

FIG. 4 is illustrating a schematic example 450 of an arrangement for applying a mechanical force on a container 1.

The example is similar to the arrangement described in relation to FIG. 3 wherein an optical sensor 6,7 is configured for measuring through a container 1 to obtain a gas pressure and/or a concentration of at least one gas and/or a gas composition inside the container 1. In the arrangement illustrated in FIG. 4, a force is applied on the container 1 using a mechanical member 8. The mechanical member 8 may be apply a force on an outer surface of the container 1, thereby compressing at least a part of the container 1.

In one example, the container 1 may be arranged measuring position. The position may be a holder for holding the container 1 during a measurement. A mechanical member 8 has at least one moving part pressing on at least one side of the container 1. On the opposite side, a non-moving part may be arranged against which the container 1 is pushed by the force of the moving part, thereby compressing at least a portion of the container 1.

In another example, the container 1 is arranged at a measurement position. The position may be a holder for the container 1. The mechanical member 8 has at least two moving part pressing on opposite sides of the container 1, thereby compressing at least a portion of the container 1.

The moving parts of the mechanical means 8 may comprise an actuator for moving the at least one moving part of the mechanical member 8 to apply a force on an outer surface of the container 1, thereby compressing the container 1. In some examples the at least one moving part may be a pneumatic piston presser, or include a stepper motor.

The gas sensing instrument 6,7 may perform a measurement of the gas inside the container 1 while the container 1 is compressed, such as during the time a force is applied on an outer surface of the container 1. The gas sensing instrument 6,7 may be used for detecting a pressure of a gas filled part 2, such as a head space 2, inside the container 1 during the compression. A deviation in the measured pressure inside the container 1 compared to an expected value, may be an indication of a leakage. For example, for an intact non-leaking container, the pressure would be approximately constant during the time the compression force is applied. In a leaky container, the pressure inside a gas filled part 2 of the container 1 would instead decrease during the time the compression force is applied. Because the linewidth of an absorption peak is related to the pressure inside a container 1, a difference between a leaking container 1 and an intact container 1 can be seen by only inspecting the linewidth of the detected signal.

In some examples, the size of the deviation in pressure (or the linewidth) can be used for estimating the size of a leak, e.g. a hole or crack in the container 1.

The compression may be applied to the container 1 in a transverse direction. In some examples, the measurements are performed by transmitting light transversely through a gas filled part 2 of the container 1, such as a head space 2, perpendicular to the direction of the applied compression.

Alternatively, the compression is applied in the same direction as the light is transmitted.

This arrangement is in particular useful for flexible containers 1, such as Blow Fill Seal package.

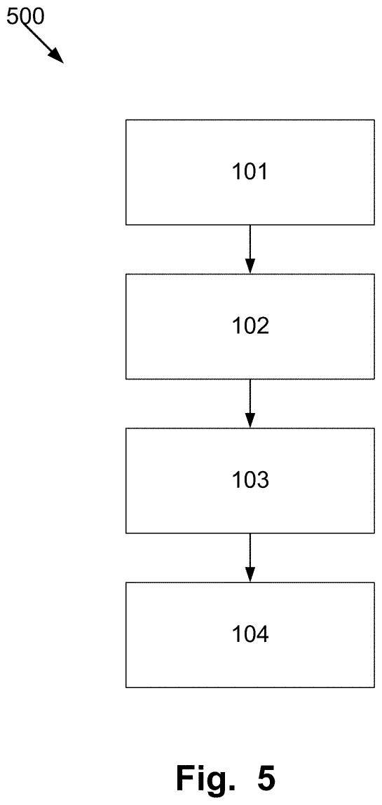

FIG. 5 is illustrating a schematic example a flow-chart 500 for a method for measuring the integrity of a container 1. The described method comprising:

Obtaining 101 a pressure inside a container by producing, filling and/or sealing the container 1 using heat or at cold conditions. This may generate a pressure inside the container 1 which differ from the surrounding. For example, if the container 1 is produced, filled and/or sealed using heat, an underpressure, such as a partial vacuum, may be generated inside the container 1 when the temperature tries to reach an equilibrium with the sounding. If there is a leak 4 in the container 1, the pressure and/or the gas composition inside the container may differ from what would be expected.

The underpressure may allow gas from a surrounding to leak into the container at a higher rate that of there was no difference in pressure. The concentration of specific gases or the composition of a gas mixture may therefore change in the container 1 should there be a leak 4. For example may atmospheric, such as normal atmosphere, gases leak into the container 1 which should normally not be detected in a non-leaking container 1. In some examples may the atmosphere around the container be intentionally altered by means of pressure and/or gas composition in order to increase sensitivity of the leak testing.

For underpressure in the container, by altering surrounding atmosphere, detecting a leak may be done by observing a gas not expected to be present in the container, or a higher concentration than expected of the gas. Additionally, and/or alternatively a different pressure than expected may be detected inside the container 1. The detected pressure may be an overpressure or an underpressure.

For overpressure in the container, detecting a leak may be done by not detecting the gas expected to be present in the container, or at a lower concentration than expected. Additionally, and/or alternatively a different pressure than expected may be detected inside the container 1.

Alternatively, in some examples when the container 1 is produced, filled and/or sealed at cold conditions, an overpressure may be generated inside the container 1 due to natural or intentional warming of the container 1. This means the gas could leak out from a leak in the container 1 since the pressure outside the container may be lower than the pressure inside the container.

By intentionally heating and/or cooling the container 1, the underpressure and/or overpressure may be amplified. The heating and or cooling of the container 1 may in some examples be performed during the measurements.

Transmitting 102 a light signal through a headspace 2 of the container 1 using an optical sensor 6, 7. The optical sensor 6, 7 being sensitive to at least one gas. The gas may be oxygen, water vapor, carbon dioxide, carbon monoxide and/or methane.

The transmitted signal may for example have a wavelength mating an absorption peak of the at least one gas.

Detecting 103 a transmitted light signal. The transmitted light signal is, at least, a part of the signal transmitted through the headspace 2.

Determining 104, based on the transmitted light signal being detected, an integrity of said container.

In some examples of a leaking container 1 the gas enters the container 1 and the concentration is thus increased. The total pressure and/or the concentration of the gas are measured to determine if there is difference between the pressure and/or gas content from what may be expected. Alternatively, in some other examples of a leaking container 1, the gas flow out of the container 1 and the concentration is thus decreased. Again, the total pressure and/or the concentration of the gas are measured to determine if there is difference between the pressure and/or gas content from what may be expected.

The method described herein can be adapted to perform the inspections inline.

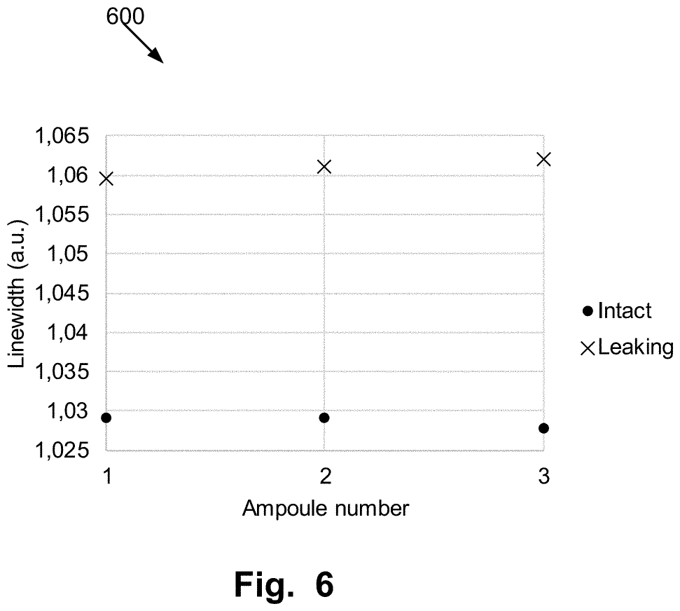

FIG. 6 is illustrating a pressure measurement 600 between ampoules being intact and having a leak. In this case, the ampoule is heated during the sealing, creating an underpressure in the container when the temperature reaches an equilibrium with the surrounding. As can be seen from the optical measurements on a gas inside the container, there is a difference in linewidth between leaking ampoule and intact, which indicates that the pressure is different.

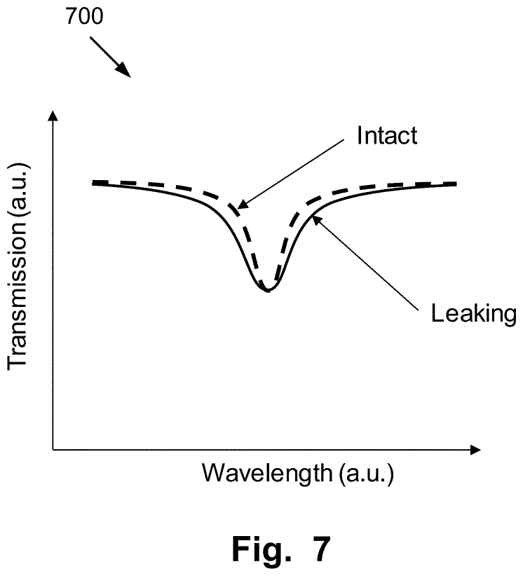

FIG. 7 is illustrating a difference 700 in linewidth due to different pressure between an intact container having an underpressure and a leaking container. A lower pressure has a narrower linewidth.

The present invention has been described above with reference to specific examples. However, other examples than the above described are equally possible within the scope of the disclosure. Different method steps than those described above, performing the method by hardware or software, may be provided within the scope of the invention. The different features and steps of the invention may be combined in other combinations than those described. The scope of the disclosure is only limited by the appended patent claims.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

1. A method of determining an integrity of a container, said method comprising:
obtaining a pressure inside said container by producing, filling and/or sealing said container using heat or at cold conditions;
transmitting a light signal through a headspace of said container using an optical sensor; said optical sensor being sensitive to at least one gas;
detecting a transmitted light signal;
determining, based on said transmitted light signal being detected, said integrity of said container.

2. The method of claim 1, having a temperature of said container to reach an equilibrium with a surrounding before transmitting the signal.

3. The method of claim 1, comprising determining said pressure inside said container and/or a concentration of said at least one gas inside said container based on said transmitted signal being detected.

4. The method of claim 1, comprising using said pressure inside said container and/or said concentration of at least one gas inside said container for determining the integrity of said container.

5. The method according to claim 1, wherein said optical sensor is a light source and a detector and said light is transmitted between said light source and said detector, wherein said detected light signal is an absorption signal, such as a Tunable diode laser absorption spectroscopy signal (TDLAS).

6. The method of claim 1, where said pressure is an under pressure, such as a partial vacuum, generated inside said container due to natural of said container after producing, filling and/or sealing said container using heat.

7. The method of claim 1, where said pressure is an under pressure, such as a partial vacuum, generated inside said container due to intentional cooling of said container after producing, filling and/or sealing said container using heat.

8. The method of claim 1, wherein said pressure is an overpressure generated inside said container due to natural warming of said container after producing, filling and/or sealing said container at cold conditions.

9. The method of claim 1, wherein said pressure is an overpressure generated inside said container due to intentional warming of said container after producing, filling and/or sealing said container at cold conditions.

10. The method of claim 1, determined said pressure inside said container using an absorption signal of said gas being present in said container.

11. The method of claim 1, comprising detecting a leak in said container, compared to an intact container, by observing an increase or a decrease of said pressure inside said container.

12. The method of claim 1, comprising detecting a leak by detecting said gas not expected to be present in said container, or a higher concentration than expected of said gas.

13. The method of claim 1, comprising detecting a leak by not detecting said gas expected to be present in said container, or a lower concentration than expected of said gas.

14. The method of claim 1, wherein said gas is present in said surrounding, such as in normal atmosphere for example the air.

15. The method of claim 1, wherein said container is an ampoule or a Blow Fill Seal package.

16. The method of claim 1, wherein a force is applied on said container using a mechanical member.

17. A system for determining an integrity of a container, wherein said system comprises:
a position for filling and/or sealing said container using heat or at cold conditions thereby obtaining a pressure inside said container;
an optical sensor for transmitting a light signal through a gas filled portion of said container, such as a headspace, and detecting a transmitted light signal; said optical sensor being sensitive to at least one gas; and
a control unit configured for determining, based on said transmitted light signal being detected, said integrity of said container.
